(19) United States
(12) Patent Application Publication
(10) Pub. No.: US 2019/0389411 A1
(43) Pub. Date: Dec. 26, 2019

(54) ARTICULABLE ACTIVE GRILL SHUTTER

(71) Applicant: AISIN TECHNICAL CENTER OF AMERICA, INC., Northville, MI (US)

(72) Inventors: Kohei HODOYA, Novi, MI (US); Stefan HEBERT, Royal Oak, MI (US)

(73) Assignee: AISIN TECHNICAL CENTER OF AMERICA, INC., Northville, MI (US)

(21) Appl. No.: 16/014,050

(22) Filed: Jun. 21, 2018

(51) Int. Cl. B60R 19/48; B60R 19/02

(52) U.S. Cl. CPC B60R 19/48; B60R 2019/486; B60R 19/023

(57) ABSTRACT

A bumper assembly for a vehicle having an upper body portion, a lower body portion, a grill opening delimited by the upper body portion and the lower body portion, a grill assembly positioned between the upper body portion and the lower body portion to face the grill opening, the grill assembly with a plurality of fins, and a link mechanism that articulates the plurality of fins between an open position when the Vehicle is moving below a predetermined speed and in an open position when the Vehicle is moving above the predetermined speed.

### BACKGROUND

### Field of the Disclosure

The present disclosure relates to grill shutters for vehicles.

### Description of the Related Art

In today's automotive industry meeting frontal impact safety requirements is becoming essential.

In order to meet these frontal impact safety requirements bumper systems with grills having predetermined curvature and/or opening have been used. Though such conventional bumper systems provide better frontal impact protection they may drastically increase drag making the vehicle less efficient. For example, air turbulence may be generated around the grill due to curves and/or openings.

Thus, a bumper system solving the aforementioned problems of safety requirements and drag reduction is desired.

### SUMMARY

Accordingly, the object of the present disclosure is to provide a bumper system that meets safety requirements at low speed and reduces drag generated by the grill shutter assembly at high speed.

In one non-limiting illustrative example, a bumper system for a vehicle is presented. The bumper system includes an upper body portion, a lower body portion, a grill opening delimited by the upper body portion and the lower body portion, a grill assembly positioned between the upper body portion and the lower body portion, the grill assembly having a plurality of fins, and a link mechanism that articulates the plurality of fins between an open position when the vehicle is moving below a predetermined speed and in an open position when the vehicle is moving above the predetermined speed.

In one non-limiting illustrative example, a bumper system for a vehicle is presented. The bumper system includes an upper body portion, a lower body portion, a grill opening delimited by the upper body portion and the lower body portion, a gill assembly positioned between the upper body portion and the lower body portion, the grill assembly having a plurality of fins, and a slit mechanism that articulates the plurality of fins between an open position when the vehicle is moving below a predetermined speed and in an open position when the vehicle is moving above the predetermined speed.

### BRIEF DESCRIPTION OF THE SEVERAL VIEWS OF THE DRAWINGS

To easily identify the discussion of any particular element or act, the most significant digit or digits in a reference number refer to the figure number in which that element is first introduced.

FIG. 1A is a cross sectional view of a bumper system of a vehicle with a grill shutter assembly in a closed position, according to certain aspects of the disclosure;

FIG. 1B is a cross sectional view of the bumper system of the vehicle with the grill shutter assembly in an open position, according to certain aspects of the disclosure;

FIG. 2A is a back perspective view of the grill assembly in the closed position, according to certain aspects of the disclosure;

FIG. 2B is a front perspective view of the grill assembly in the closed position, according to certain aspects of the disclosure;

FIG. 2C is a back perspective view of the grill assembly in the open position, according to certain aspects of the disclosure;

FIG. 2D is a front perspective view of the grill assembly in the open position, according to certain aspects of the disclosure;

FIG. 3A is a cross sectional view of a link mechanism of the grill assembly in the closed position, according to certain aspects of the disclosure;

FIG. 3B is a cross sectional view of the link mechanism of the grill shutter assembly in the open position, according to certain aspects of the disclosure;

FIG. 4A is a cross sectional view of a slit mechanism of the grill shutter assembly in the closed position, according to certain, aspects of the disclosure; and

FIG. 4B is a cross sectional view of the slit mechanism of the grill shutter assembly in the open position, according to certain aspects of the disclosure.

### DETAILED DESCRIPTION

All publications, patent applications, patents, and other references mentioned herein are incorporated by reference in their entirety. Further, the materials, methods, and examples discussed herein are illustrative only and are not intended to be limiting.

In the drawings, like reference numerals designate identical or corresponding parts throughout the several views. Further, as used herein, the words “a”, “an”, and the like include a meaning of “one or more”, unless stated otherwise. The drawings are generally drawn not to scale unless specified otherwise or illustrating schematic structures or flowcharts.

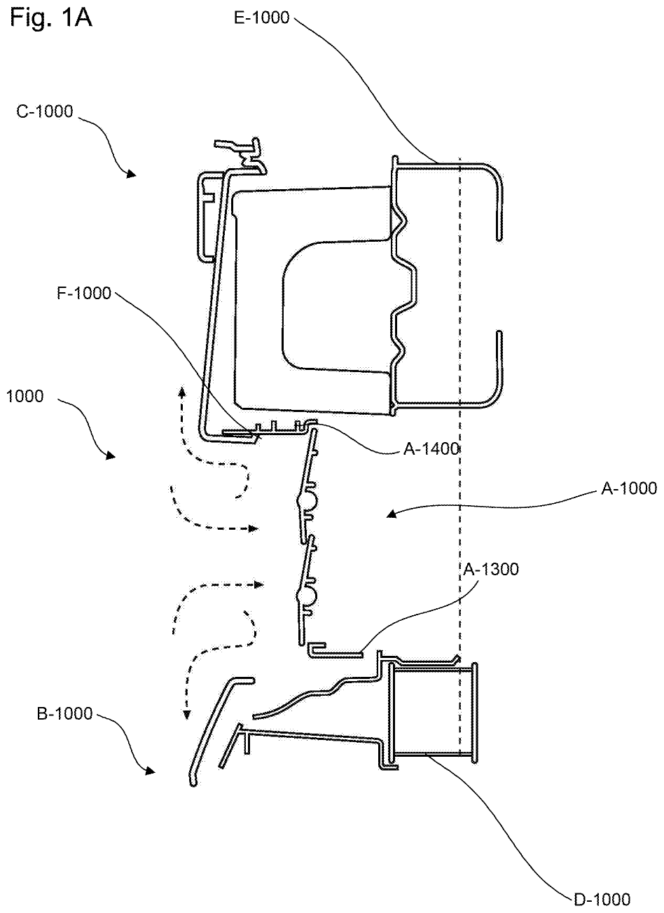

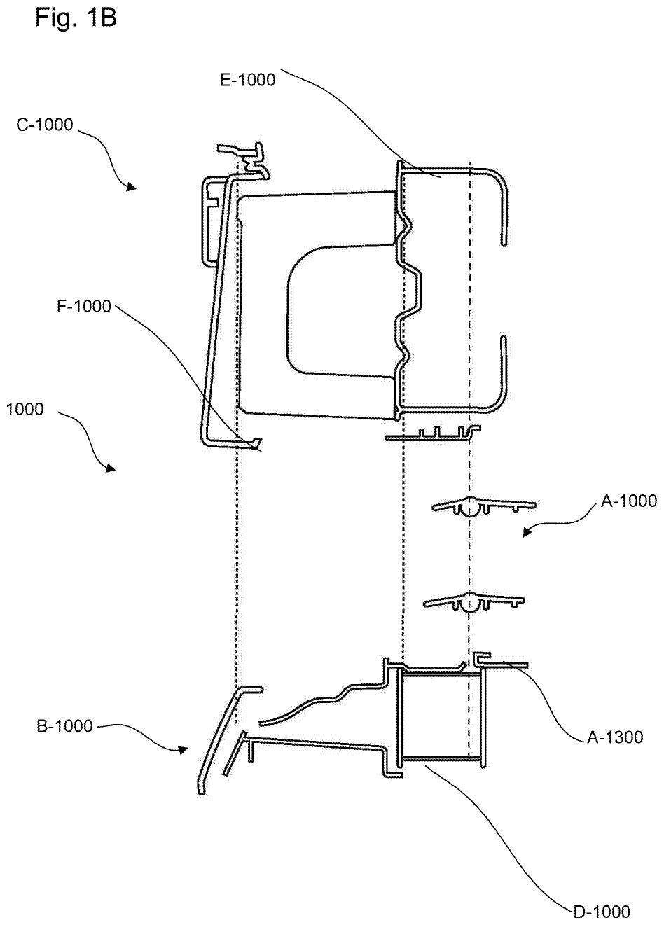

FIGS. 1A-1B are cross sectional views of a bumper system 1000 of a vehicle 100 with a grill assembly A-1000 in a closed position, according to certain aspects of the disclosure.

The bumper system 1000 presented meets safety regulation when the vehicle 100 is below a predetermined minimum speed Vmin, e.g. between 20 Km/h and 60 Km/h and preferably between 30 Km/h and 50 Km/h, and reduces drag on the vehicle 100 when the vehicle 100 is a above a predetermined maximum speed Vmax, e.g. between 20 Km/h and 60 Km/h and preferably between 30 Km/h and 50 Km/h, by articulating a grill assembly A-1000 from an open position and a closed position.

The bumper system 1000 can include an upper body portion C-1000, a lower body portion B-1000, a grill opening F-1000 delimited by the upper body portion C-1000 and the lower body portion B-1000, an upper reinforcement portion E-1000 affixed to the upper body portion C-1000, a lower reinforcement portion D-1000 affixed to the lower body portion B-1000, and a grill assembly A-1000 positioned between the upper body portion C-1000 and the lower body portion B-1000.

The grill assembly A-1000 can be articulated in the open position to provide a plurality of openings and meets safety requirement when the vehicle 100 is below the predetermined minimum speed Viriin and in the closed position to obstruct the plurality of openings and reduce drag generate by, the vehicle 100.

As used herein, the term “front” and/or “forward” refers to the region of the bumper system 1000 closest to a front terminal portion of the vehicle 100, while the term “back” and/or “backward” refers to the region of the bumper system 1000 closest to a rear terminal portion of the vehicle 100.

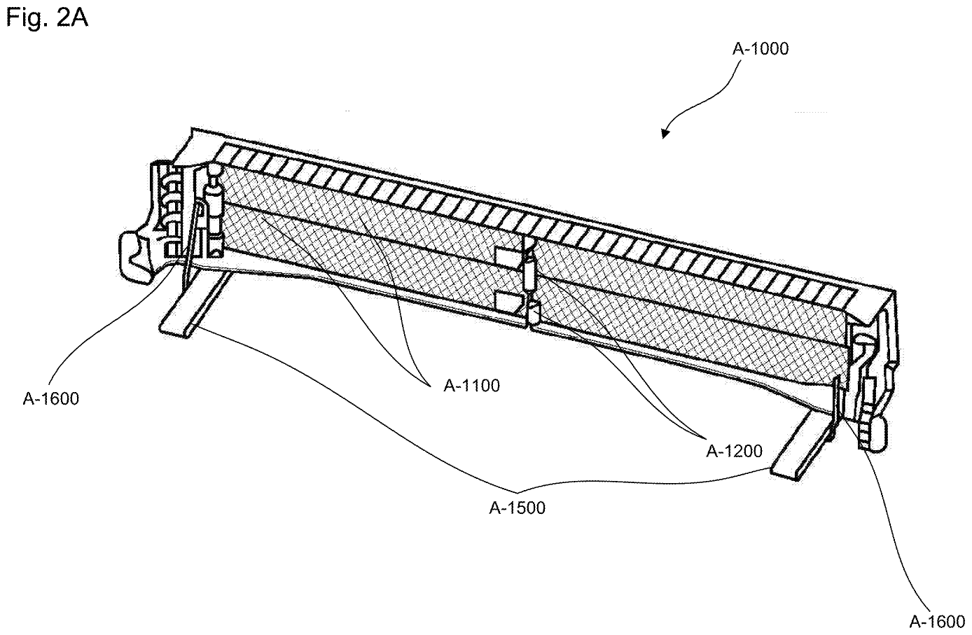

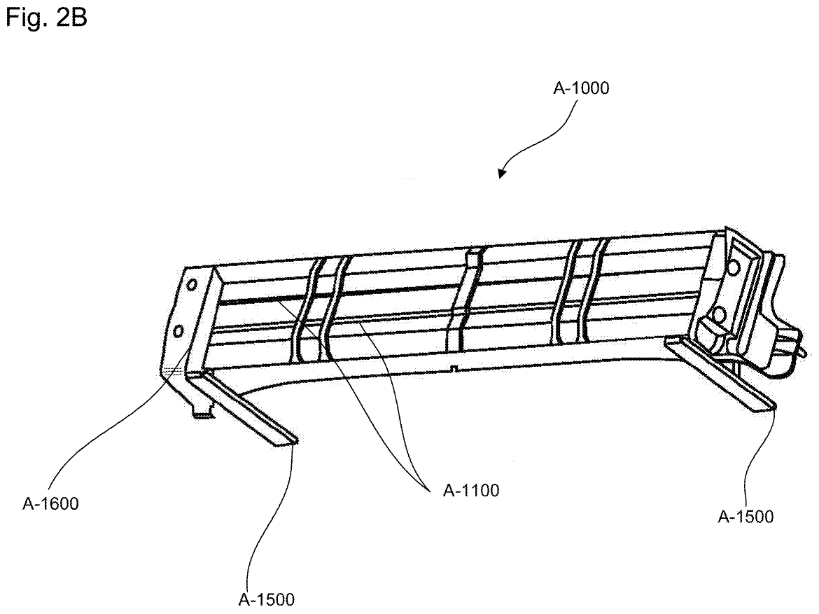

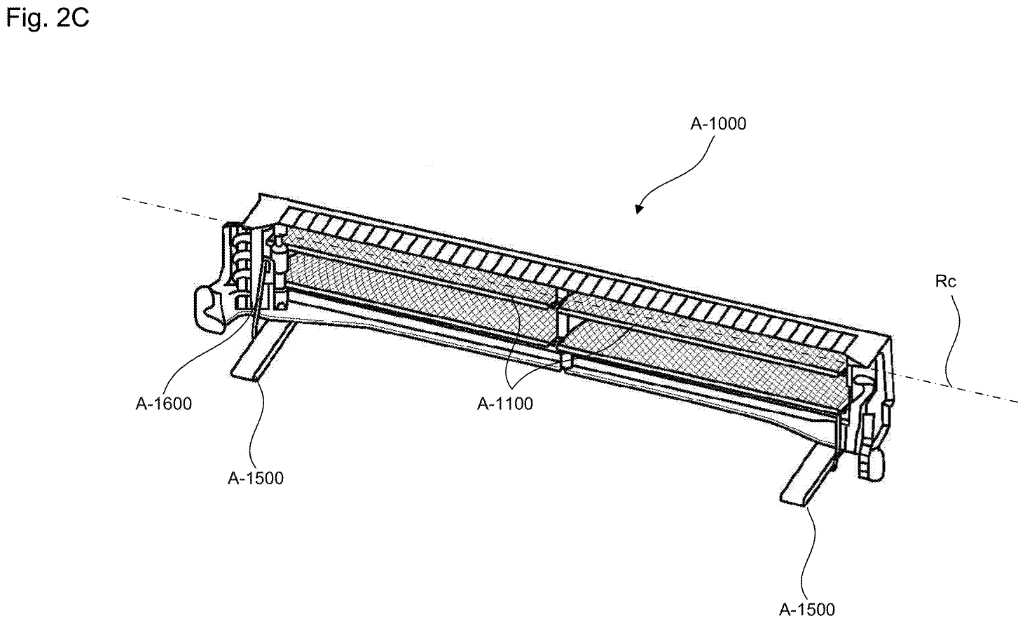

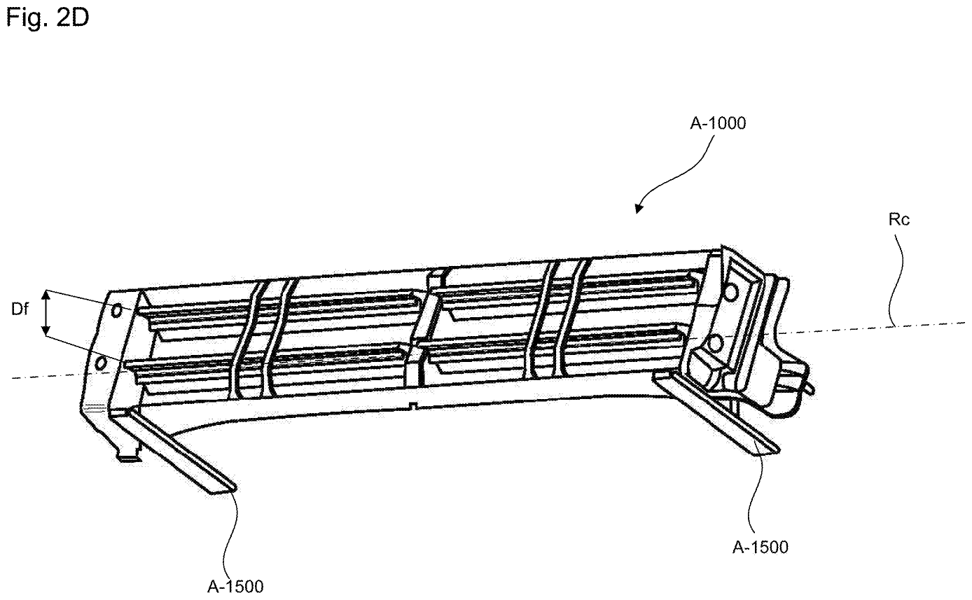

FIGS. 2A-2D are a back perspective view of the grill assembly A-1000 in the closed position, a front perspective view of the grill assembly A-1000 in the closed position, a back perspective view of the grill assembly A-1000 in the open position, and a front perspective view of the grill assembly A-1000 in the open position, according to certain aspects of the disclosure.

The grill assembly A-1000 can include a plurality of pivots A-1200, a plurality of fins A-1100 rotatably mounted on the plurality of pivots A-1200, a stop A-1400 mounted between the upper body portion C-1000 and the plurality of fins A-1100, a pair of rail A-1500 mounted between the lower body portion B-1000 and the plurality of fins A-1100, a pair shoes A-1300 mounted on the pair of rails A-1500, and a link mechanism A-1600 extending between the plurality of fins A-1100 and the pair of rails A-1500.

In the open position, the plurality of fins A-1100 are articulated substantially horizontally to provide spacing between each other to meet safety requirements, as illustrated in FIGS. 1B, 2C, and 2D. The spacing between each fin of the plurality of fins A-1100 can be determined by an inter-fin distance Df specified by safety regulations, e.g. National Highway Traffic Safety Administration. For example, the inter-fin distance Df can be between 50 mm and 100 mm, and preferably between 60 mm and 80 mm.

In the closed position, the plurality of fins A-1100 are articulated substantially vertically and move backward to provide air flow restriction and/or channeling to limit turbulence and reduce drag.

The plurality of pivots A-1200 can provide rotation of the plurality of fins A-1100 around a plurality of axes Re positioned substantially horizontally when the grill assembly A-1000 can be articulated between the open position and the closed position.

The pair of shoes A-1300 can slide on the pair of rails A-1500 to push backward the plurality of fins A-1100 when the grill assembly A-1000 is articulated between the open position and the closed position.

The link mechanism A-1600 can provide rotation and translation of the plurality of fins A-1100.

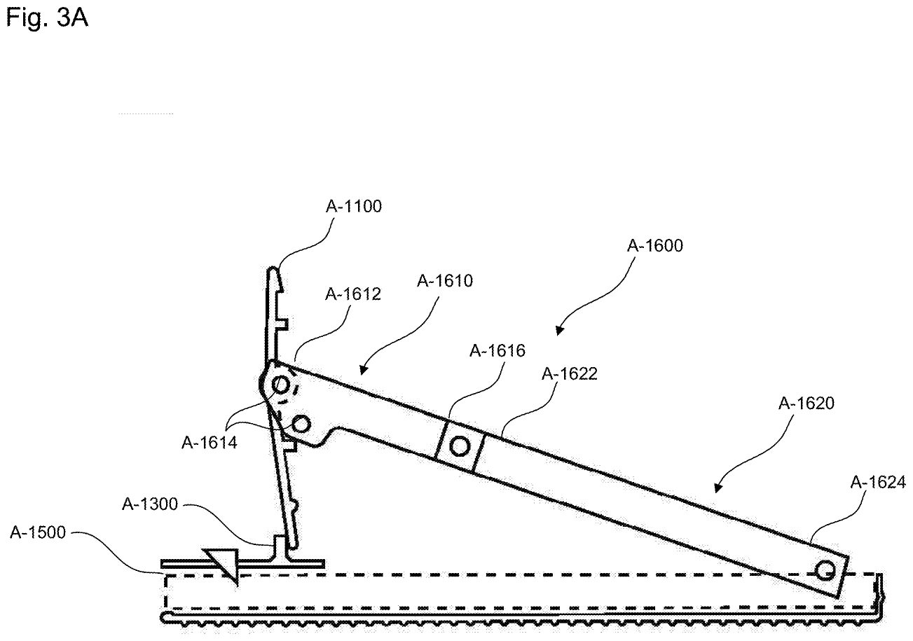

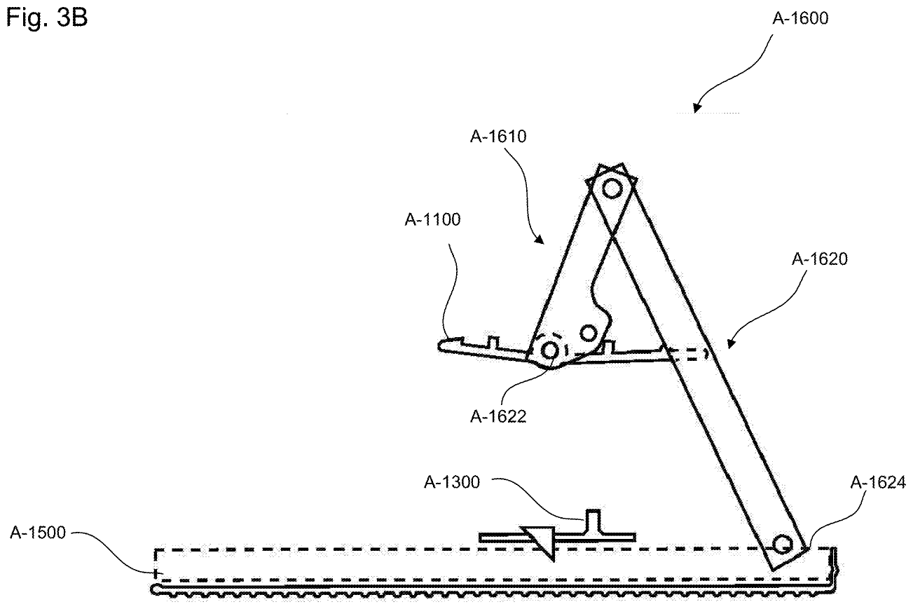

FIGS. 3A-3B is a cross sectional view of a link mechanism A-1600 of the grill assembly A-1000 in the closed position and in the open position, according to certain aspects of the disclosure.

The link mechanism A-1600 can include a pair of link forearms A-1610 rotatably affixed to the plurality of fins A-1100 and a pair of link arms A-1620 rotatably affixed to the pair of link forearms A-1610.

Each link forearm of the pair of link forearms A-1610 can include a first forearm terminal portion A-1612 with two forearm pivots A-1614 rotatably affixed to a consecutive fin A-1100, and a second forearm terminal portion A-1616 rotatably affixed to a consecutive link arm of the pair of link arms A-1620. The two forearm pivots A-1614 provide rotation of the consecutive fin A-1100 to articulate the consecutive fin A-1100 from the closed position where the consecutive fin A-1100 is positioned vertically to the open position where the consecutive fin A-1100 is positioned horizontally.

Each link arm of the pair of link arms A-1620 can include a first arm terminal portion A-1622 rotatably affixed to a consecutive second forearm terminal portion A-1616 and a second arm terminal portion A-1624 rotatably affixed to a terminal portion of the pair of rails A-1500.

In addition, to articulate the plurality of fins A-1100 from the closed position to the open position the plurality of fins can be staggered to each other, e.g. terminal portions of each fin are in contact from each other as illustrated in FIGS. 1A, 2A, and 2B, and the shoe A-1300 and/or the stop A-1400 can slide along the pair of rails A-1500 to push the plurality of fins A-1100 in the backward direction and rotate the plurality of fins A-1100 from the vertical orientation to the horizontal orientation.

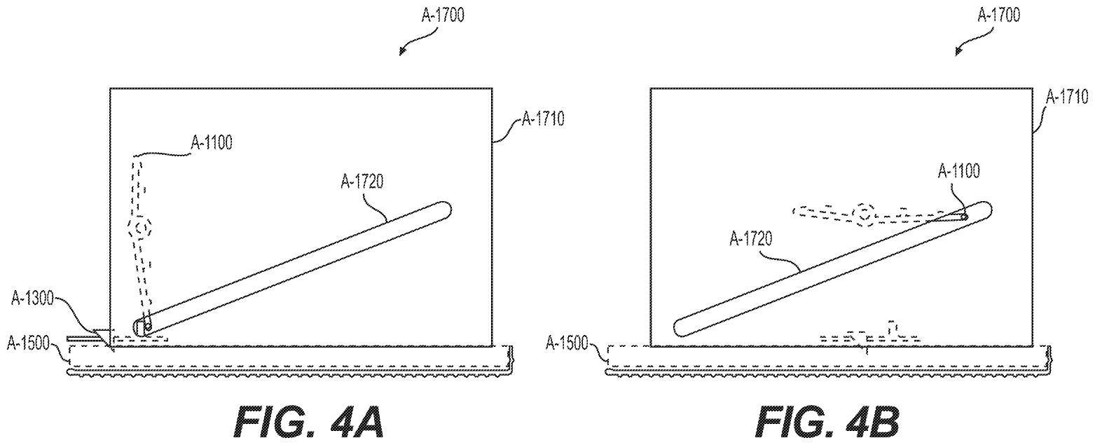

FIGS. 4A-4B is a cross sectional view of a slit mechanism A-1700 of the grill assembly A-1000 in the closed position and in the open position, according to certain aspects of the disclosure.

In addition or in substitution of the link mechanism A-1600, the grill assembly A-1000 can include a slit mechanism A-1700 to articulate the plurality of fins A-1100 from the open position to the closed position.

The slit mechanism A-1700 can include a pair of support walls A-1710 positioned laterally on the plurality of fins A-1100 and a plurality of grooves A-1720 on the pair of support walls A-1710.

The plurality of grooves A-1720 can receives the plurality of pivots A-1200 to allow the plurality of fins A-1100 to slide along the plurality of grooves and articulate the plurality of fins. A-1100 from the open position to the closed positioned.

The plurality of grooves A-1720 can have geometrical configurations, e.g. shape, length, width and/or depth, to rotate the plurality of fins A-1100 from the horizontal orientation, as illustrated in FIG. 4B, to the vertical orientation, as illustrated in FIG. 4A. For example, each groove of the plurality of grooves A-1720 can have a V-shape that extend along a length of the support walls A-1710 to allow the plurality of fins A-1100 to rotate from the horizontal orientation to the vertical orientation as the shoe A-1300 and/or the stop A-1400 are displaced backwardly and push the plurality of fins backwardly.

The foregoing discussion discloses and describes merely exemplary embodiments of an object of the present disclosure. As will be understood by those skilled in the art, an object of the present disclosure may be embodied in other specific forms without departing from the spirit or essential characteristics thereof. Accordingly, the present disclosure is intended to be illustrative, but not limiting of the scope of an object of the present disclosure as well as the claims.

Numerous modifications and variations on the present disclosure are possible in light of the above teachings. It is therefore to be understood that within the scope of the appended claims, the disclosure may be practiced otherwise than as specifically described herein.

What is claimed is:

1. A bumper assembly for a vehicle, comprising:
an upper body portion;
a lower body portion;
a grill opening delimited by the upper body portion and the lower body portion;
a grill assembly positioned between the upper body portion and the lower body portion to face the grill opening, the grill assembly including
a plurality of fins, and
a link mechanism that articulates the plurality of fins between an open position when the vehicle is moving below a predetermined speed and a closed position when the vehicle is moving above the predetermined speed.

2. The bumper assembly of claim 1, wherein the link mechanism includes a pair of rails and a pair of members that articulably link the plurality of fins to the pair of rails.

3. The bumper assembly of claim 2, wherein each member of the pair of members includes a forearm rotatably affixed to a corresponding fin of the plurality of fins.

4. The bumper assembly of claim 3, wherein each member includes an arm extending between the forearm and the rail.

5. The bumper assembly of claim 4, wherein the arm includes a first terminal portion that slides on the rail.

6. The bumper assembly of claim 1, wherein the grill assembly further includes a pair of shoes connected to the pair of rails that translates between the open position and the closed position.

7. The bumper assembly of claim 1, wherein in the open position each fin of the plurality of fins are positioned substantially horizontally and in the closed position each fin is positioned substantially vertically.

8. A bumper assembly fore vehicle, comprising:
an upper body portion;
a lower body portion;
a grill opening delimited by the upper body portion and the lower body portion;
a grill assembly positioned between the upper body portion and the lower body portion to face the grill opening, the grill assembly including
a plurality of fins, and
a slit mechanism that articulates the plurality of fins between an open position when the vehicle is moving below a predetermined speed and in an open position when the vehicle is moving above the predetermined speed.

9. The bumper assembly of claim 8, wherein the slit mechanism includes a pair of support walls and a groove on each support wall of the pair of support walls that slidably receive a lateral portion of the plurality of fins.

10. The bumper assembly of claim 9, wherein the groove has a V-shape to allow the plurality of fins to rotate around a substantially horizontal axis and to translate backwardly when the plurality of fins is articulated between the open position and the closed position.

11. The bumper assembly of claim 10, wherein the grill assembly further includes a stop that pushes the plurality of fins backwardly along the groove.

12. The bumper assembly of claim 8, wherein the grill assembly further includes a pair of shoes connected to the pair of rails that translates between the open position and the closed position.

13. The bumper assembly of claim 8, wherein in the open position each fin of the plurality of fins are positioned substantially horizontally and in the closed position each fin is positioned substantially vertically.
